(19) United States
(12) Patent Application Publication
(10) Pub. No.: US 2007/0157472 A1
(43) Pub. Date: Jul. 12, 2007

(54) Utility knife with releasable blade retention mechanism

(75) Inventor: James M. Critelli, Fuquay-Varina, NC (US)

Correspondence Address: COATS & BENNETT, PLLC, 1400 Crescent Green, Suite 300, Cary, NC, 27518, US

(73) Assignee: Cooper Brands, Inc.

(21) Appl. No.: 11/329,586

(22) Filed: Jan. 11, 2006

(51) Int. Cl. B26B 1/08

(52) U.S. Cl. 30/162; 30/335

(57) ABSTRACT

A utility knife has a body comprising a blade-receiving cavity defined by first and second generally opposing walls; a retention element laterally moveable with respect to the cavity via a hole in one of the walls; an actuator moveable longitudinally relative to the cavity between a retention position and a release position; the actuator having a recess opening towards the cavity and a cam surface; wherein the hole and the recess are aligned when the actuator is in the release position and offset when the actuator is in the retention position; the actuator in the retention position causes the cam surface to engage the retention element to force the retention element to a protruding position in the cavity; the actuator in the release position allows the retention element to be withdrawn, allowing the blade to be removed. Also, a related method of assembly.

### BACKGROUND OF THE INVENTION

The present invention is directed generally to utility knives having a releasable blade retention mechanism.

Utility knives are used for a variety of tasks, such as box cutting, carpet cutting, and the like. Such utility knives employ cutting blades typically having a trapezoid shape with a razor sharp cutting edge along the long lower side and two small U-shaped notches along an opposing shorter upper side for mating the blade to the main body of the utility knife. Over time, the cutting edge of the blade may become dulled, the blade may break, or the blade may otherwise need to be replaced. As such, it is common for utility knives to allow the blade to be replaced. In very simple utility knives, the housing may be formed of two halves that are joined together by a central screw. Replacement of the blade in such devices requires the screw to be removed, the housing halves separated, removal and replacement of the blade, and finally reassembly of the housing. Such an arrangement is shown, for example, in U.S. Pat. Nos. 5,099,578 and 3,192,624. Other utility knives use modified versions of this concept, with housing halves that pivot with respect to one another, or other means to hold the housing halves together. Nevertheless, the manipulation of the housing required to change the cutting blades is less than ideal with such designs. Accordingly, some designs have been proposed that use a “quick release” mechanism that allows the cutting blade to be replaced via the front slit in the housing. Examples of such designs are shown in U.S. Pat. Nos. 6,829,827 and 6,553,674, and U.S. patent application Ser. No. 11/108,322, the later of which is incorporated herein by reference. However, even these quick-release mechanisms may be less than ideal for some circumstances, and there remains a need for alternative utility knife designs that allow for easy cutting blade replacement.

### SUMMARY OF THE INVENTION

In one illustrative embodiment, the present invention provides a utility knife having a novel releasable blade locking mechanism that allows the cutting blade to be replaced easily and/or a method of assembling the same.

In one embodiment, the present invention provides a utility knife comprising: a body comprising a blade-receiving cavity extending to a blade slot opening; the cavity defined by first and second generally opposing walls; the second wall having at least a first hole therethrough; a first retention element moveably coupled to the body so as to be laterally moveable with respect to the cavity via the first hole; an actuator coupled to the body and moveable longitudinally relative to the cavity between a retention position and a release position; the actuator having a first recess opening towards a longitudinal centerline of the cavity and a first cam surface proximate the first recess; wherein the first hole and the first recess are aligned when the actuator is in the release position and offset when the actuator is in the retention position; wherein movement of the actuator to the retention position causes the first cam surface to engage the first retention element to force the first retention element inward to a first position extending at least partially into the cavity; wherein movement of the actuator to the release position allows the first retention element to move away from the cavity centerline to a second position closer to the actuator than the first position. The first retention element may comprise a curved body, such as a sphere. The body may comprise a handle and a head moveably coupled to the handle, wherein the head includes the blade-receiving cavity, the slot, the actuator, and the first retention element. A blade may be disposed partially in the cavity; the blade having at least one retention notch; wherein movement of the actuator to the retention position causes the first retention element to extend into the retention notch so as to couple the blade to the body. The first cam surface may help define the first recess. The actuator may slide longitudinally relative to the body and/or may be biased toward the retention position, such as by a spring disposed longitudinally adjacent the actuator. The utility knife may employ one retention element, or a plurality of retention elements to engage one or more notches on the cutting blade. A corresponding method is described.

In another embodiment, the present invention provides a utility knife comprising: a body comprising a blade-receiving cavity extending to a blade slot opening; the cavity defined by first and second generally opposing walls; a blade retention means for releasably coupling a blade disposed in the cavity to said body while said blade is in an operative cutting position. The second wall may comprise at least a first hole therethrough; and the blade retention means may comprise: an actuator coupled to the body and moveable longitudinally relative to the cavity between a retention position and a release position; and a first retention element moveably coupled to the body so as to be laterally moveable outward away from a centerline of the cavity when the actuator is in the release position, and disposed at least partially in the cavity when the actuator is in the retention position. The blade retention means may further comprise a second retention element moveably coupled to the body so as to be laterally moveable away from a centerline of the cavity when the actuator is in the release position, and disposed at least partially in the cavity when the actuator is in the retention position, the second retention element distinct from the first retention element and longitudinally spaced therefrom. The body may comprise a handle and a head moveably coupled to the handle, wherein the head includes the blade-receiving cavity, the actuator, and the first retention element. The actuator may be biased toward the retention position. A corresponding method is described.

In yet another embodiment, the present invention provides a utility knife comprising: a body comprising a blade-receiving cavity extending to a blade slot opening; the cavity defined by first and second spaced walls; a blade disposed partially in the cavity; the blade having at least a first retention notch; an actuator coupled to the body and moveable longitudinally relative to the cavity between a retention position and a release position; a first ball moveably coupled to the body; wherein movement of the actuator to the retention position causes the ball to move laterally so as to extend into the retention notch and thereby lock the blade relative to the cavity; wherein movement of the actuator to the release position allows the ball to move laterally out of the retention notch so as to unlock the blade relative to the cavity and thereby allow the blade to be removed from the cavity. The blade may further comprise a second retention notch, with the knife further comprising a second ball moveably coupled to the body; wherein movement of the actuator to the retention position causes the first and second balls to move laterally so as to extend into the first and second retention notches respectively; wherein movement of the actuator to the release position allows the first and second balls to move laterally out of the first and second retention notches respectively. A corresponding method is described.

In another embodiment, the present invention provides a method of assembling a utility knife, comprising: providing a utility knife body, the body comprising: a blade-receiving cavity defined by first and second generally opposing walls; the second wall having at least a first hole therethrough; an actuator coupled to the body and moveable longitudinally relative to the cavity between a retention position and a release position; the actuator having a first recess opening towards a longitudinal centerline of the cavity and a first cam surface; a first retention element moveably coupled to the body so as to be laterally moveable with respect to the cavity via the first hole; the method further comprising causing the actuator to assume the retention position such that the first recess is offset from the first hole and forcing the first retention element laterally toward the centerline by engaging the first retention element with the first cam surface; and moving the actuator to the release position and thereby aligning the first recess and the first retention element to allow the first retention element to retract away from the centerline. The method may further comprise inserting a blade into the cavity and moving the actuator from the release position to the retention position. The method may further comprise removing the blade from the cavity with the actuator in the release position. The second wall may comprise a second hole, the utility knife body may further comprise a second retention element moveably coupled to the body so as to be laterally moveable with respect to the cavity via the second hole; and the actuator may further comprise a second recess, spaced from the first recess, opening towards the centerline and a second cam surface; and the method may be such that causing the actuator to assume the retention position comprises offsetting the second recess from the second retention element and moving the actuator to the release position comprises aligning the second recess and the second retention element. The method may further comprise inserting a blade into the cavity and moving the actuator from the release position to the retention position; wherein the blade includes a notch disposed distally from a cutting edge; wherein moving the actuator to the retention position causes the first retention element to be disposed in the notch while the blade is disposed in the cavity.

### BRIEF DESCRIPTION OF THE DRAWINGS

FIG. 1 shows a utility knife constructed in accordance with one embodiment of the present invention.

FIG. 2 shows a partially exploded view of a utility knife constructed in accordance with another embodiment of the present invention.

FIG. 3 shows a perspective view of a utility knife head of FIG. 2 with a blade attached.

FIG. 4 shows a sectional view with the actuator in the locked or retention position along line IV-IV.

FIG. 5 shows the sectional view of FIG. 4 with the actuator in the release position.

### DETAILED DESCRIPTION OF THE INVENTION

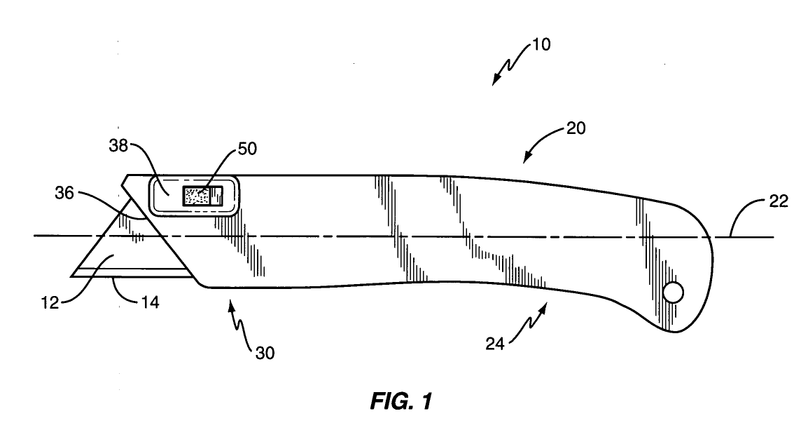

As illustrated in FIG. 1, a utility knife, generally designated 10, is shown constructed according to one embodiment of the present invention. The knife 10 includes a cutting blade 12 and a main body 20. The blade 12, as is conventional, has a generally trapezoidal shape, with a lower cutting edge 14 and two notches 16 on its upper edge. It should be noted that while the present description is in the context of a conventional trapezoidal shaped blade, the cutting blade 12 may alternatively take any other configuration known in the art.

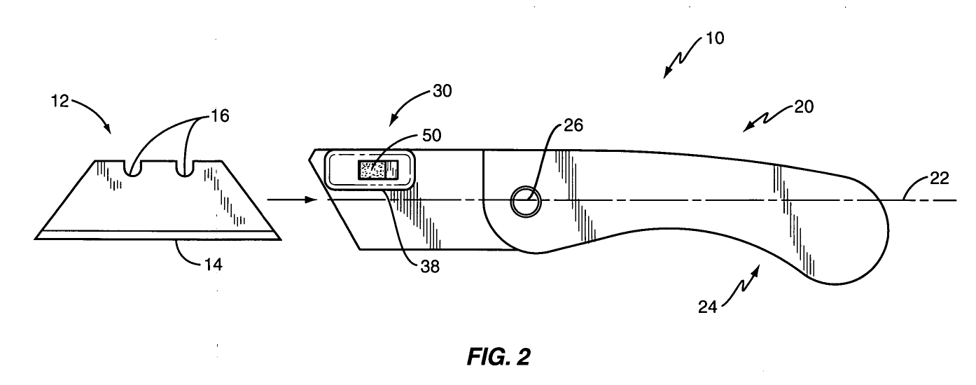

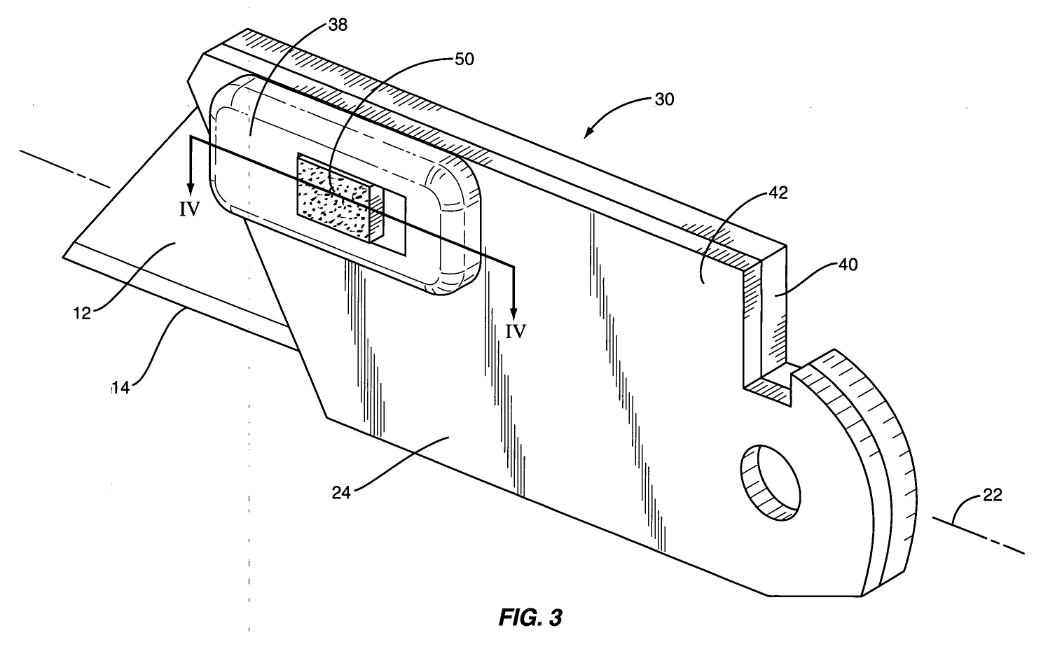

The main body 20 is generally elongate, extending along longitudinal axis 22. The main body 20 includes a handle section 24 and a head section 30. The head section 30 may be permanently fixed relative to the handle 24, including integral therewith, or may be moveable relative thereto. For example, in some embodiments, the head section 30 may be pivotally attached to the handle section 24 so that the utility knife 10 may be open and closed via a folding action about pivot 26. See FIG. 2. For such foldable embodiments, a suitable mechanism, such as a locking detent mechanism (not shown) known in the art, should be employed to prevent unintentional folding during use. The main body 20 should be formed of a suitably strong material, such as steel, aluminum, or hard plastic, but the handle section 24 may include areas of soft elastomeric material on the exterior surfaces as is desired in order to increase comfort and/or to increase grip. In addition, the handle section 24 may advantageously include a suitable belt/pocket clip if desired.

The head 30 includes a blade-receiving cavity 32, an actuator 50, and two retention elements 70. The cavity 32 is advantageously disposed along the longitudinal axis 22 of the main body 20, such that the centerline 34 of the cavity 32 is parallel with the longitudinal axis 22. Two opposing, spaced apart, and generally parallel walls 40,42 help define the blade-receiving cavity 32. The cavity 32 extends forwardly away from the handle 24, and terminates at a slot-shaped opening 36 between the walls 40,42 sized to have the blade 12 extending/inserted therethrough. Wall 40 may be solid, while wall 42 includes two holes 44 that extend laterally therethrough to the blade-receiving cavity 32. These holes 44 are positioned so as to overlap with the blade's notches 16 when the blade 12 is properly inserted into the blade-receiving cavity 32. Wall 42 includes a small cover 38 attached to its outer or outboard face, which may be snap-fitted to wall 42.

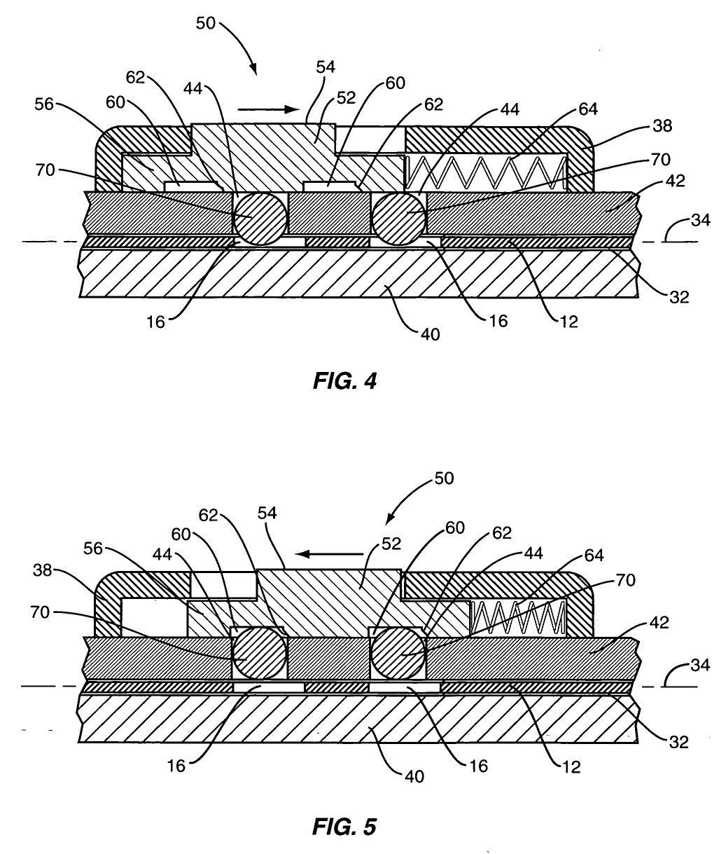

The actuator 50 is moveably housed in cover 38, with the outboard portion 54 of the actuator body 52 extending through (or accessible via) a suitable opening in the cover 38 so as to be physically accessible to a user. This outboard portion 54 advantageously includes suitable texturing on its outer surface to increase the user's grip thereagainst. The inboard portion 56 of the actuator body 52 includes two spaced apart recesses 60 that face inward toward the cavity's centerline 34. The inboard portion 56 also includes two cam surfaces 62, one associated with each of the recesses 60. The actuator 50 is moveable between a lock or retention position (FIG. 4) and a release position (FIG. 5). Advantageously, the movement of the actuator 50 between these positions is via a sliding motion that is generally parallel to the cavity's centerline 34. In the release position, the recesses 60 are aligned with the holes 44 in wall 42. In the lock position, the recesses 60 are offset from the holes 44. The actuator 50 may advantageously be biased toward the lock position by suitable means, such as spring 64.

The retention elements 70, which are distinct from the actuator 50, are moveably disposed in respective holes 44 in wall 42 and move generally laterally toward and away from the actuator 50 so as to selectively protrude into cavity 32 to at least centerline 34. The retention elements 70 advantageously take the form of spherical balls, but other shapes may be used. For example, the retention elements 70 may take the form of short pins, with angled or curved (e.g., hemispherical) tips disposed toward the centerline 34. In some embodiments, the retention elements 70 may be biased away from the actuator 50, such as by springs (not shown), integral with or external to the retention elements 70; in other embodiments, the retention elements 70 are not biased.

As illustrated in FIG. 4, with the actuator 50 in the lock position (FIG. 4), the recesses 60 are offset from holes 44, and the cam surfaces 62 engage retention elements 70. This arrangement forces the retention elements 70 inward toward the cavity's centerline 34. Thus, the retention elements 70 are forced to assume positions protruding into the blade-receiving cavity 32. The retention elements 70 may be forced inward such that they contact the opposing wall 40, but this is not required in all embodiments. With a blade 12 properly disposed in cavity 32, at least the tips of the retention elements 70 extend into the blade's notches 16. Removal of the blade 12 out slot 36 is prevented by the interference of the retention elements 70 against the boundary of the notches 16. Thus, the blade 12 is retained against forces that might otherwise pull the blade 12 out of cavity 32. Advantageously, the retention elements 70 are sized so that they completely fill their respective notches 16 when the actuator 50 is in the retention position, to thereby firmly anchor blade 12 in cavity 32.

As illustrated in FIG. 5, with the actuator 50 in the release position, the recesses 60 are generally aligned with the retention elements 70. This allows the retention elements 70 to move outward, away from the centerline 34, and into recesses 60. The retention elements 70 can thus withdraw from their protruding positions to corresponding withdrawn positions that are closer to wall 42. In these withdrawn positions, the retention elements 70 are retracted from the notches 16, allowing the blade 12 to be removed via front slot 36. Advantageously, the inward surfaces of the retention elements 70 are configured so that a forward displacement of the blade 12 imparts a lateral component of force on the retention elements 70 to move the retention elements 70 laterally outward. For example, if the retention elements 70 are balls, the interaction of the blade 12 with the curved face of the balls 70 can help urge the balls 70 laterally outward. Of course, this laterally outward movement of the retention elements 70 is prevented by the actuator 50 when the actuator 50 is in the lock position.

The cam surfaces 62 on the actuator 50 may, if desired, be simple flat surfaces disposed parallel to the cavity's centerline 34. However, in order to facilitate movement of the actuator 50 from the release position to the lock position, the cam surfaces 62 may advantageously include angled faces adjacent the recesses 60. For example, the cam surfaces 62 may be formed, in whole or in part, by chamfers at the front wall of recesses 60. With this arrangement, the angled interface of the cam surfaces 62 and balls 70 will naturally help force the balls 70 toward the centerline 34 as the actuator 50 is moved toward the lock position.

As outlined above, the blade retention mechanism (or means) of the actuator 50 with recesses 60 and associated cam surfaces 62, and the separate retention elements 70, allow. the blade 12 to be selectively retained in cavity 32 in a position suitable for cutting operations. The retention elements 70 move laterally through holes 44 so as to selectively protrude into cavity 32 so as to engage blade 12 or be retracted toward actuator 50 so as to allow the blade 12 to be removed/replaced.

The discussion above has assumed that there are two retention elements 70 in the blade retention mechanism, corresponding to the two notches 16 in a conventional utility knife blade 12. However, there may be only one retention element 70 (and corresponding hole 44 in wall 42) in some embodiments. And, it should be understood that the utility knife 10 may include other features known in the art, such as used/replacement blade storage bays, retractable blade safety guards, and the like, without departing from the scope of the present invention.

The various components of the main body 20 may be made of any suitable material known in the art, such as hardened steel, aluminum, plastics (reinforced and otherwise), ceramics, and the like. The blade 12 may be made from any material known in art of utility blades, such as stainless steel, with or without a hardened surface coating, such as titanium nitride or the like.

The present invention may, of course, be carried out in other specific ways than those herein set forth without departing from the essential characteristics of the invention. The present embodiments are, therefore, to be considered in all respects as illustrative and not restrictive, and all changes coming within the meaning and equivalency range of the appended claims are intended to be embraced therein.

What is claimed is:

1. A utility knife, comprising:
a body comprising a blade-receiving cavity extending to a blade slot opening; said cavity defined by first and second generally opposing walls; said second wall having at least a first hole therethrough;
a first retention element moveably coupled to said body so as to be laterally moveable with respect to said cavity via said first hole;
an actuator coupled to said body and moveable longitudinally relative to said cavity between a retention position and a release position; said actuator having a first recess opening towards a longitudinal centerline of said cavity and a first cam surface proximate said first recess;
wherein said first hole and said first recess are aligned when said actuator is in said release position and offset when said actuator is in said retention position;
wherein movement of said actuator to said retention position causes said first cam surface to engage said first retention element to force said first retention element to a first protruding position extending at least partially into said cavity; and
wherein movement of said actuator to said release position allows said first retention element to move away from said cavity centerline to a second position closer to said actuator than said first position.

2. The utility knife of claim 1 wherein said first retention element comprises a curved body.

3. The utility knife of claim 2 wherein said first retention element comprises a sphere.

4. The utility knife of claim 1 wherein said body comprises a handle and a head moveably coupled to said handle, wherein said head includes said blade-receiving cavity, said slot, said actuator, and said first retention element.

5. The utility knife of claim 1 further comprising a blade disposed partially in said cavity; said blade having at least one retention notch; wherein movement of said actuator to said retention position causes said first retention element to extend into said retention notch so as to couple said blade to said body.

6. The utility knife of claim 1 wherein said first cam surface helps define said first recess.

7. The utility knife of claim 1 wherein said actuator is distinct from said first retention element and slides longitudinally relative to said body.

8. The utility knife of claim 1 wherein said actuator is biased toward said retention position.

9. The utility knife of claim 8 further comprising a spring disposed longitudinally adjacent said actuator and biasing said actuator toward said retention position.

10. The utility knife of claim 1:
wherein said second wall further comprises a second hole therethrough spaced from said first hole;
wherein said actuator further comprises a second recess opening towards said centerline and a second cam surface proximate said second recess;
further comprising a second retention element moveably coupled to said body so as to be laterally moveable with respect to said cavity via said second hole; said second retention element distinct from said first retention element and said actuator;
wherein movement of said actuator to said retention position causes said second cam surface to engage said second retention element to force said second retention element to a third protruding position extending at least partially into said cavity; and
wherein movement of said actuator to said release position allows said second retention element to move away from said cavity centerline to a forth position closer to said actuator than said third position.

11. The utility knife of claim 10 wherein said first and second retention elements are spheres.

12. The utility knife of claim 10 further comprising a blade disposed partially in said cavity; said blade having first and second retention notches; wherein movement of said actuator to said retention position causes said first retention element to extend into said first retention notch and said second retention element to extend into second retention notch so as to couple said blade to said body.

13. The utility knife of claim 10 wherein said second cam surface helps define said second recess.

14. The utility knife of claim 10:
wherein said first and second retention elements are spheres;
wherein said body comprises a handle and a head moveably coupled to said handle, wherein said head includes said blade-receiving cavity, said slot, said actuator, and said first and second retention elements;
further comprising a blade disposed partially in said cavity; said blade having first and second retention notches; wherein movement of said actuator to said retention position causes said first retention element to extend into said first retention notch and said second retention element to extend into second retention notch so as to couple said blade to said body;
further comprising a spring operatively coupled to said actuator and biasing said actuator toward said retention position; and
wherein said first cam surface helps define said first recess and said second cam surface helps define said second recess.

15. A utility knife, comprising:
a body comprising a blade-receiving cavity extending to a blade slot opening; said cavity defined by first and second generally opposing walls; and
a blade retention means for releasably coupling a blade disposed in said cavity to said body while said blade is in an operative cutting position.

16. The utility knife of claim 15 wherein said second wall comprises at least a first hole therethrough and said blade retention means comprises:
an actuator coupled to said body and moveable longitudinally relative to said cavity between a retention position and a release position; and
a first retention element moveably coupled to said body so as to be laterally moveable away from a centerline of said cavity when said actuator is in said release position, and disposed at least partially in said cavity when said actuator is in said retention position.

17. The utility knife of claim 16 wherein said blade retention means further comprises a second retention element moveably coupled to said body so as to be laterally moveable away from a centerline of said cavity when said actuator is in said release position, and disposed at least partially in said cavity when said actuator is in said retention position, said second retention element distinct from said first retention element and longitudinally spaced therefrom.

18. The utility knife of claim 15 wherein said body comprises a handle and a head moveably coupled to said handle, wherein said head includes said blade-receiving cavity and said blade retention means.

19. A utility knife, comprising:
a body comprising a blade-receiving cavity extending to a blade slot opening; said cavity defined by first and second generally opposing walls;
a blade disposed partially in said cavity; said blade having at least a first retention notch;
an actuator coupled to said body and moveable longitudinally relative to said cavity between a retention position and a release position;
a first ball moveably coupled to said body;
wherein movement of said actuator to said retention position causes said ball to move laterally so as to extend into said retention notch and thereby lock said blade relative to said cavity; and
wherein movement of said actuator to said release position allows said ball to laterally withdraw out of said retention notch so as to unlock said blade relative to said cavity and thereby allow said blade to be removed from said cavity.

20. The utility knife of claim 19 wherein said blade further comprises a second retention notch; further comprising a second ball moveably coupled to said body; wherein movement of said actuator to said retention position causes said first and second balls to move laterally so as to extend into said first and second retention notches respectively; wherein movement of said actuator to said release position allows said first and second balls to withdraw laterally out of said first and second retention notches respectively.

21. A method of assembling a utility knife, comprising:
providing a utility knife body, said body comprising:
a blade-receiving cavity defined by first and second generally opposing walls; said second wall having at least a first hole therethrough;
an actuator coupled to said body and moveable longitudinally relative to said cavity between a retention position and a release position; said actuator having a first recess opening towards a longitudinal centerline of said cavity and a first cam surface;
a first retention element moveably coupled to said body so as to be laterally moveable with respect to said cavity via said first hole;
causing said actuator to assume said retention position such that said first recess is offset from said first hole and forcing said first retention element laterally toward said centerline by engaging said first retention element with said first cam surface; and
moving said actuator to said release position and thereby aligning said first recess and said first retention element to allow said first retention element to retract away from said centerline.

22. The method of claim 21 further comprising inserting a blade into said cavity and moving said actuator from said release position to said retention position while said blade is in an operative cutting position.

23. The method of claim 22 further comprising removing said blade from said cavity with said actuator in said release position.

24. The method of claim 21 wherein said second wall comprises a second hole; wherein said utility knife body further comprises a second retention element moveably coupled to said body so as to be laterally moveable with respect to said cavity via said second hole; wherein said actuator further comprises a second recess, spaced from said first recess, opening towards said centerline and a second cam surface; wherein:
said causing said actuator to assume said retention position comprises offsetting said second recess from said second retention element; and
said moving said actuator to said release position comprises aligning said second recess and said second retention element.

25. The method of claim 21 further comprising inserting a blade into said cavity and moving said actuator from said release position to said retention position; wherein said blade includes a notch disposed distally from a cutting edge; wherein said moving said actuator to said retention position causes said first retention element to be disposed in said notch while said blade is disposed in said cavity.
